(19) United States
(12) Patent Application Publication
(10) Pub. No.: US 2024/0400941 A1
(43) Pub. Date: Dec. 5, 2024

(54) METHOD FOR REMOVING DISCHARGE SURFACE TREATMENT COATING

(71) Applicant: IHI Corporation, Tokyo (JP)

(72) Inventor: Kazuki ITO, Tokyo (JP)

(73) Assignee: IHI Corporation, Tokyo (JP)

(21) Appl. No.: 18/806,825

(22) Filed: Aug. 16, 2024

Related U.S. Application Data
(63) Continuation of application No. PCT/JP2022/041029, filed on Nov. 2, 2022.

(30) Foreign Application Priority Data
Apr. 21, 2022 (JP) 2022-070110

(51) Int. Cl. C11D 3/04; B08B 3/08; C11D 1/72; C11D 3/12

(52) U.S. Cl. CPC C11D 3/044; B08B 3/08; C11D 1/72; C11D 3/1213

(57) ABSTRACT

Provided is a method for removing a discharge surface treatment coating coated on a surface of a component, wherein the discharge surface treatment coating includes chromium, and the method includes a main washing step of performing main washing of the discharge surface treatment coating with a main washing liquid that includes sodium permanganate and a primary alkali metal hydroxide.

### CROSS REFERENCE TO RELATED APPLICATIONS

This application is a continuation application of International Application No. PCT/JP2022/041029, filed on Nov. 2, 2022, which claims priority to Japanese Patent Application No. 2022-070110, filed on Apr. 21, 2022, the entire contents of which are incorporated by reference herein.

### BACKGROUND

### 1. Technical Field

The present invention relates to a method for removing a discharge surface treatment coating, and particularly, to a method for removing a discharge surface treatment coating coated on the surface of a component.

### 2. Description of the Related Art

Conventionally, a sliding surface of a high-temperature component such as a turbine blade of an aircraft gas turbine engine has been coated with a discharge surface treatment coating made from a hard metal or the like excellent in durability and wear resistance. The discharge surface treatment coating is a coating formed through a discharge surface treatment. The discharge surface treatment is a surface treatment technique for stably forming a functional coating excellent in durability and wear resistance by means of discharge energy using an electrode including a coating component such as a hard metal (see WO 2004/029329).

### SUMMARY

Incidentally, when a discharge surface treatment coating coated on the surface of a component is thinned due to wear through the operation of the actual machine, such as an aircraft jet engine, and the like, the thinned discharge surface treatment coating is physically removed by mechanical polishing, and a new discharge surface treatment coating is coated. However, when the thinned discharge surface treatment coating is removed by mechanical polishing, the component may be damaged during mechanical polishing.

Thus, an object of the present invention is to provide a method for removing a discharge surface treatment coating, capable of removing the discharge surface treatment coating while suppressing damage to a component covered with the discharge surface treatment coating.

A method for removing a discharge surface treatment coating according to the present disclosure is a method for removing a discharge surface treatment coating coated on a surface of a component, wherein the discharge surface treatment coating includes chromium, and the method includes a main washing step of performing main washing of the discharge surface treatment coating with a main washing liquid that includes sodium permanganate and a primary alkali metal hydroxide.

The method for removing the discharge surface treatment coating according to the present disclosure may include a pre-washing step of pre-washing, before the main washing step, the discharge surface treatment coating with a pre-washing liquid that includes a secondary alkali metal hydroxide, includes no oxidizing agent, and has a strong alkaline than the main washing liquid.

In the method for removing the discharge surface treatment coating according to the present disclosure, the pre-washing liquid may include a surfactant.

The method for removing the discharge surface treatment coating according to the present disclosure may include a post-washing step of post-washing the discharge surface treatment coating with a post-washing liquid that includes a tertiary alkali metal hydroxide, incudes no oxidizing agent, and has a strong alkaline than the main washing liquid.

In the method for removing the discharge surface treatment coating according to the present disclosure, the post-washing liquid may include a surfactant.

The method for removing the discharge surface treatment coating according to the present disclosure may include a preliminary washing step of preliminarily washing the discharge surface treatment coating with a preliminary washing liquid that includes a resolvent.

In the method for removing the discharge surface treatment coating according to the present disclosure, the preliminary washing liquid may include a surfactant and an alkaline agent.

In the method for removing the discharge surface treatment coating according to the present disclosure, a concentration of the sodium permanganate included in the main washing liquid may be within a range of 1% or more and 10% or less.

In the method for removing the discharge surface treatment coating according to the present disclosure, the primary alkali metal hydroxide may be sodium hydroxide or potassium hydroxide.

In the method for removing the discharge surface treatment coating according to the present disclosure, the secondary alkali metal hydroxide may be sodium hydroxide or potassium hydroxide.

In the method for removing the discharge surface treatment coating according to the present disclosure, the tertiary alkali metal hydroxide may be sodium hydroxide or potassium hydroxide.

With the above-described structure, a discharge surface treatment coating can be removed while suppressing damage to a component covered with the discharge surface treatment coating.

### BRIEF DESCRIPTION OF THE DRAWINGS

FIG. 1 is a flowchart illustrating a structure of a method for removing a discharge surface treatment coating in an embodiment of the present disclosure.

FIG. 2 is a cross-sectional view illustrating a configuration of a component provided with a discharge surface treatment coating in an embodiment of the present disclosure.

FIG. 3A is a low-magnification overall photograph of a discharge surface treatment coating, illustrating a cross-sectional observation result of a metallic structure in a test piece before heat exposure in an embodiment of the present disclosure.

FIG. 3B is a high-magnification enlarged photograph of a discharge surface treatment coating, illustrating a cross-sectional observation result of a metallic structure in a test piece before heat exposure in an embodiment of the present disclosure.

FIG. 4A is a low-magnification overall photograph of a discharge surface treatment coating, illustrating a cross-sectional observation result of a metallic structure in a test piece after heat exposure in an embodiment of the present disclosure.

FIG. 4B is a high-magnification enlarged photograph of a discharge surface treatment coating, illustrating a cross-sectional observation result of a metallic structure in a test piece after heat exposure in an embodiment of the present disclosure.

FIG. 5A is a low-magnification overall photograph of a discharge surface treatment coating, illustrating a cross-sectional observation result of a metallic structure in a test piece subjected to a washing treatment of example 1 in an embodiment of the present disclosure.

FIG. 5B is a high-magnification enlarged photograph near the surface of a discharge surface treatment coating, illustrating a cross-sectional observation result of a metallic structure in a test piece subjected to the washing treatment of example 1 in an embodiment of the present disclosure.

FIG. 5C is a high-magnification enlarged photograph inside a discharge surface treatment coating, illustrating a cross-sectional observation result of a metallic structure in a test piece subjected to the washing treatment of example 1 in an embodiment of the present disclosure.

FIG. 6A is a low-magnification overall photograph of a discharge surface treatment coating, illustrating a cross-sectional observation result of a metallic structure in a test piece subjected to a washing treatment of comparative example 1 in an embodiment of the present disclosure.

FIG. 6B is a high-magnification enlarged photograph of a discharge surface treatment coating, illustrating a cross-sectional observation result of a metallic structure in a test piece subjected to the washing treatment of comparative example 1 in an embodiment of the present disclosure.

### DESCRIPTION OF THE EMBODIMENTS

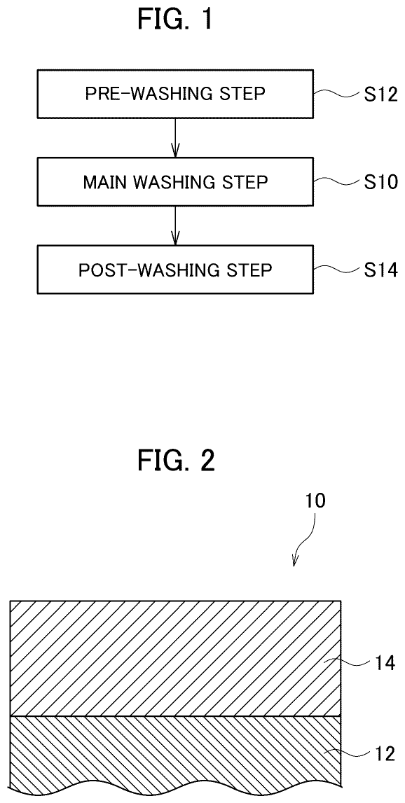

An embodiment according to the present disclosure will be described using the drawings. FIG. 1 is a flowchart illustrating the structure of a method for removing a discharge surface treatment coating. The method for removing a discharge surface treatment coating is a method for removing a discharge surface treatment coating coated on the surface of a component. First, the discharge surface treatment coating will be described.

FIG. 2 is a cross-sectional view illustrating the configuration of a component 10 including a discharge surface treatment coating. The component 10 including the discharge surface treatment coating includes a component 12 and a discharge surface treatment coating 14 coated on the surface of the component 12. The component 12 is, for example, a gas turbine component used in a high-temperature environment, such as a jet engine component for an aircraft, a supercharger component for a vehicle, and an industrial gas turbine component. An example of the jet engine component for an aircraft is a turbine blade that slides with a shroud. The component 12 is formed with, for example, a heat-resistant alloy, such as a nickel alloy, a cobalt alloy, or an iron alloy.

The discharge surface treatment coating 14 is a coating formed through a discharge surface treatment. First, the discharge surface treatment will be described. The discharge surface treatment is a surface treatment method in which a powder of a material to be coated is solidified into an electrode and placed in insulating oil together with the component 12 and voltage is applied to perform a surface treatment. By repeating a pulse-like discharge between the electrode and the component 12, the electrode material moves to the surface of the component 12 to be fused and layered to form the discharge surface treatment coating 14.

The discharge surface treatment coating 14 includes chromium (Cr). Since the discharge surface treatment coating 14 includes chromium, the chromium included in the discharge surface treatment coating 14 can be selectively oxidized to form an oxide layer including chromium oxide (Cr₂O₃) when the discharge surface treatment coating 14 is exposed to heat in a high-temperature oxidizing atmosphere. The oxide layer functions as a protective oxide layer having excellent oxidation resistance. In addition, chromium oxide (Cr₂O₃) functions as a high-temperature lubricant and can improve wear resistance.

The discharge surface treatment coating 14 can be formed with, for example, a cobalt alloy containing cobalt (Co) as a main component, chromium (Cr), and silicon (Si). The main component in an alloy is the alloy component that occupies the largest proportion in the alloy. As the cobalt alloy, a Stellite alloy or a Tribaloy alloy can be used.

The Stellite alloy is a cobalt alloy containing Cr, Si, W, C, and the like, with the remainder made from Co and inevitable impurities. The Stellite alloy contains, for example, cobalt as a main component, Cr in amount of 20% by mass or more and 32.5% by mass or less, and Si in an amount of 2.0% by mass or less, and has excellent heat resistance and excellent oxidation resistance. The Stellite alloy is hard and has excellent wear resistance since a fine carbide such as WC is dispersed. As the Stellite alloy, for example, a Stellite 31 alloy or the like can be used.

The Tribaloy alloy is a cobalt alloy containing Cr, Si, Mo, and the like, with the remainder made from Co and inevitable impurities. The Tribaloy alloy contains, for example, cobalt as a main component, Cr in an amount of 8.5% by mass or more and 18% by mass or less, and Si in an amount of 1.3% by mass or more and 3.7% by mass or less, and has excellent heat resistance and excellent oxidation resistance. The Tribaloy alloy is hard and has excellent wear resistance since a fine intermetallic compound of Mo and Si is dispersed. As the Tribaloy alloy, a Tribaloy T-400 alloy, a T-800 alloy, and the like can be used.

By repeating a pulse-like discharge between the electrode and the component 12, the electrode material moves to the component 12 to be fused and layered to form the discharge surface treatment coating 14, and thus the discharge surface treatment coating 14 has a porous metallic structure. The thickness of the discharge surface treatment coating 14 can be, for example, within a range of 5 to 3000 μm. When the discharge surface treatment coating 14 is exposed to heat in a high-temperature environment, chromium oxide (Cr₂O₃) formed through oxidation of chromium included in the discharge surface treatment coating 14 is formed on the surface of the discharge surface treatment coating 14 and in the pore part.

After the operation of an actual machine such as an aircraft jet engine, the discharge surface treatment coating 14 tends to be thinned to have a reduced thickness due to wear. When a coating formation is performed again through the discharge surface treatment for the thinned coating thickness, a boundary is made between the discharge surface treatment coating 14 after heat exposure and the newly formed discharge surface treatment coating 14, and thus the discharge surface treatment coating 14 is easily peeled off. Thus, the discharge surface treatment coating 14 after heat exposure is removed, and then coating formation of a new discharge surface treatment coating 14 is performed.

Next, returning to FIG. 1, a method for removing the discharge surface treatment coating 14 coated on the surface of the component 12 will be described in detail. The method for removing the discharge surface treatment coating 14 includes a main washing step (S10). The method for removing the discharge surface treatment coating 14 may include a pre-washing step (S12) before the main washing step (S10). The method for removing the discharge surface treatment coating 14 may include a post-washing step (S14) after the main washing step (S10). The method for removing the discharge surface treatment coating 14 may include the pre-washing step (S12) before the main washing step (S10) and the post-washing step (S14) after the main washing step (S10). Each process is described in detail below.

The main washing step (S10) is a step of main washing the discharge surface treatment coating 14 using a main washing liquid including sodium permanganate and a primary alkali metal hydroxide. In the main washing step (S10), mainly, the chromium included in the discharge surface treatment coating 14 is actively oxidized to form chromium oxide (Cr₂O₃), which is an amphoteric oxide. By dissolving the formed chromium oxide (Cr₂O₃), the metallic structure of the discharge surface treatment coating 14 can be made more porous.

The main washing liquid includes sodium permanganate and a primary alkali metal hydroxide. The main washing liquid may further include a surfactant or the like. The main washing liquid may contain sodium permanganate and a primary alkali metal hydroxide, and the remainder can be made from a solvent. The main washing liquid may include sodium permanganate, a primary alkali metal hydroxide, and a surfactant, and the remainder may be made from a solvent. The solvent of the main washing liquid is preferably water, for example.

Sodium permanganate has a function as an oxidizing agent for oxidizing chromium included in the discharge surface treatment coating 14. Sodium permanganate can oxidize chromium included in the discharge surface treatment coating 14 to promote the formation of chromium oxide (Cr₂O₃). Commercially available products and the like can be used for sodium permanganate.

The concentration of sodium permanganate in the main washing liquid can be within a range of 1% or more and 10% or less, and is preferably within a range of 3% or more and 7% or less. This is because if the concentration of sodium permanganate is lower than 1%, the formation of chromium oxide (Cr₂O₃) may decrease. This is because if the concentration of sodium permanganate is 10%, chromium oxide (Cr₂O₃) can be formed sufficiently.

The primary alkali metal hydroxide has a function as an alkaline agent for dissolving chromium oxide (Cr₂O₃). Since chromium oxide (Cr₂O₃) is an amphoteric oxide, chromium oxide (Cr₂O₃) can be dissolved by an alkaline agent. The primary alkali metal hydroxide can dissolve chromium oxide (Cr₂O₃) formed through oxidation of chromium included in the discharge surface treatment coating 14 with sodium permanganate. In addition, the primary alkali metal hydroxide can dissolve chromium oxide (Cr₂O₃) included in the oxide layer formed during heat exposure on the surface of the discharge surface treatment coating 14. Furthermore, the primary alkali metal hydroxide can dissolve chromium oxide (Cr₂O₃) formed in the pore part of the discharge surface treatment coating 14 during heat exposure. Thus, the metallic structure of the discharge surface treatment coating 14 can be made more porous.

The primary alkali metal hydroxide is preferably sodium hydroxide or potassium hydroxide. Since sodium hydroxide and potassium hydroxide are strong alkaline agents, the solubility of chromium oxide (Cr₂O₃) is improved. Commercially available products and the like can be used for sodium hydroxide or potassium hydroxide.

The concentration of the primary alkali metal hydroxide in the main washing liquid can be within a range of 10% or more and 20% or less, and is preferably 14%. This is because the solubility of chromium oxide (Cr₂O₃) decreases when the concentration of the primary alkali metal hydroxide is lower than 10%. This is because chromium oxide (Cr₂O₃) can be sufficiently dissolved when the concentration of the primary alkali metal hydroxide is 20%.

As the surfactant, for example, an anionic surfactant, a non-ionic surfactant, or the like can be used. As the anionic surfactant, a fatty acid-based surfactant, an alkylbenzene-based surfactant, a higher alcohol-based surfactant, an α-olefin-based surfactant, or the like can be used. As the non-ionic surfactant, a fatty acid-based surfactant, a higher alcohol-based surfactant, an alkylphenol-based surfactant, or the like can be used. As the surfactant, for example, a linear alkylbenzene sulfonate, a polyoxyethylene alkyl ether sulfate, a poly (oxyethylene) nonylphenyl ether, or the like can be used. When a surfactant is added to the main washing liquid, the concentration of the surfactant in the main washing liquid is preferably within a range of more than 0% and 15% or less.

In the main washing, for example, the discharge surface treatment coating 14 can be immersed in the main washing liquid and washed. The temperature of the main washing liquid can be, for example, room temperature. The main washing liquid may be warmed and used. The immersion time in the main washing liquid can be 60 to 120 minutes, for example. After the discharge surface treatment coating 14 is subjected to the main washing, it is preferably washed with water to remove the main washing liquid. Note that the main washing is not limited to immersion, and other washing methods such as spray, shower, and jet may be used.

By performing the main washing of the discharge surface treatment coating 14, the main washing liquid penetrates into the pore part of the discharge surface treatment coating 14. Sodium permanganate in the main washing liquid actively oxidizes chromium included in the discharge surface treatment coating 14 to form chromium oxide (Cr₂O₃). The primary alkali metal hydroxide in the main washing liquid dissolves the formed chromium oxide (Cr₂O₃). Consequently, it becomes possible to cause the metallic structure of the discharge surface treatment coating 14 to be more porous and to cause the discharge surface treatment coating 14 to be easily peeled off and removed.

Further, since the metallic structure of the component 12 is denser than that of the discharge surface treatment coating 14, the penetration of the main washing liquid into the component 12 is suppressed. Thus, the damage of the component 12 can be suppressed not only when the component 12 is formed with a heat-resistant alloy not including chromium but also when the component 12 is formed with a heat-resistant alloy including chromium.

The method for removing the discharge surface treatment coating 14 may include a pre-washing step (S12) before the main washing step (S10). The pre-washing step (S12) is a step of pre-washing, before the main washing step (S10), the discharge surface treatment coating 14 with a pre-washing liquid including a secondary alkali metal hydroxide, including no oxidizing agent, and having a strong alkaline than that of the main washing liquid.

In the pre-washing step (S12), mainly, chromium oxide (Cr₂O₃), which is an amphoteric oxide, included in the oxide layer formed on the surface of the discharge surface treatment coating 14 is dissolved and removed. This enables the main washing liquid to easily penetrate into the discharge surface treatment coating 14 in the main washing step (S10).

The pre-washing liquid includes a secondary alkali metal hydroxide. The pre-washing liquid may further include a surfactant or the like. The pre-washing liquid includes a secondary alkali metal hydroxide, and the remainder can be made from a solvent. The pre-washing liquid can include a secondary alkali metal hydroxide and a surfactant, and the remainder may be made from a solvent. The solvent of the pre-washing liquid is preferably water, for example. Further, the pre-washing liquid does not include any oxidizing agent. This is because in the pre-washing step (S12), mainly, chromium oxide (Cr₂O₃) included in the oxide layer formed on the surface of the discharge surface treatment coating 14 is dissolved, and thus it is not necessary to actively oxidize chromium included in the discharge surface treatment coating 14.

The secondary alkali metal hydroxide has a function as an alkaline agent for dissolving chromium oxide (Cr₂O₃), which is an amphoteric oxide. The secondary alkali metal hydroxide is preferably sodium hydroxide or potassium hydroxide. Chromium oxide (Cr₂O₃) included in the oxide layer formed on the surface of the discharge surface treatment coating 14 during heat exposure is dissolved by the secondary alkali metal hydroxide. Consequently, the oxide layer formed on the surface of the discharge surface treatment coating 14 is removed, and thus in the main washing step (S10), the main washing liquid can easily penetrate into the discharge surface treatment coating 14.

The concentration of the secondary alkali metal hydroxide in the pre-washing liquid can be within a range of 40% or more and 50% or less and is preferably 41%. This is because when the concentration of the secondary alkali metal hydroxide is within a range of 40% or more and 50% or less, chromium oxide (Cr₂O₃) included in the oxide layer formed on the surface of the discharge surface treatment coating 14 during heat exposure can be sufficiently dissolved.

The pre-washing liquid has a strong alkaline than the main washing liquid. This improves the solubility of chromium oxide (Cr₂O₃) included in the dense oxide layer formed on the surface of the discharge surface treatment coating 14. For example, as the secondary alkali metal hydroxide of the pre-washing liquid, an alkali metal hydroxide which is more alkaline than the primary alkali metal hydroxide of the main washing liquid can be used. When the secondary alkali metal hydroxide of the pre-washing liquid and the primary alkali metal hydroxide of the main washing liquid are the same alkali metal hydroxide, the concentration of the secondary alkali metal hydroxide in the pre-washing liquid may be made higher than the concentration of the primary alkali metal hydroxide in the main washing liquid.

As the surfactant, for example, an anionic surfactant, a non-ionic surfactant, or the like can be used. Examples of the surfactant used include a linear alkylbenzene sulfonate, a polyoxyethylene alkyl ether sulfate, and a poly (oxyethylene) nonylphenyl ether. The surfactant of the pre-washing liquid may be the same as or different from that of the main washing liquid. When a surfactant is added to the pre-washing liquid, the concentration of the surfactant in the pre-washing liquid can be within a range of more than 0% and 0.5% or less and is preferably 0.1% or less.

In the pre-washing, for example, the discharge surface treatment coating 14 can be immersed in the pre-washing liquid and washed. The temperature of the pre-washing liquid can be, for example, room temperature. The pre-washing liquid may be warmed and used. The immersion time in the pre-washing liquid can be 120 to 180 minutes, for example. After the discharge surface treatment coating 14 is pre-washed, it is preferably washed with water to remove the pre-washing liquid. Note that the pre-washing is not limited to immersion, and other washing methods such as spray, shower, and jet may be used.

By pre-washing the discharge surface treatment coating 14, the secondary alkali metal hydroxide in the pre-washing liquid dissolves chromium oxide (Cr₂O₃) included in the oxide layer formed on the surface of the discharge surface treatment coating 14 during heat exposure. Consequently, the oxide layer formed on the surface of the discharge surface treatment coating 14 is removed, and thus in the main washing step (S10), the main washing liquid can easily penetrate into the discharge surface treatment coating 14, thereby promoting the main washing.

The method for removing the discharge surface treatment coating 14 may include a post-washing step (S14) after the main washing step (S10). The post-washing step (S14) is a step of post-washing, after the main washing step (S10), the discharge surface treatment coating 14 with a post-washing liquid which includes a tertiary alkali metal hydroxide, includes no oxidizing agent, and has a strong alkaline than that of the main washing liquid.

In the post-washing step (S14), mainly, even when chromium oxide (Cr₂O₃) remains in the discharge surface treatment coating 14 after the main washing step (S10), the residual chromium oxide (Cr₂O₃) can be dissolved and removed.

The post-washing liquid includes a tertiary alkali metal hydroxide. The post-washing liquid may further include a surfactant or the like. The post-washing liquid includes a tertiary alkali metal hydroxide, and the remainder can be made from a solvent. The post-washing liquid can include a tertiary alkali metal hydroxide and a surfactant, and the remainder can be made from a solvent. The solvent is preferably water, for example. The post-washing liquid does not include any oxidizing agent. This is because in the post-washing step (S14), mainly, chromium oxide (Cr₂O₃) remaining in the discharge surface treatment coating 14 after the main washing step (S10) is dissolved and removed. As the post-washing liquid, the same washing liquid as the pre-washing liquid may be used, and a different washing liquid may be used.

The tertiary alkali metal hydroxide functions as an alkaline agent for dissolving chromium oxide (Cr₂O₃), which is an amphoteric oxide. The tertiary alkali metal hydroxide is preferably sodium hydroxide or potassium hydroxide. Chromium oxide (Cr₂O₃) remaining in the discharge surface treatment coating 14 after the main washing step (S10) can be dissolved by the tertiary alkali metal hydroxide and removed.

The concentration of the tertiary alkali metal hydroxide in the post-washing liquid can be within a range of 40% or more and 50% or less, and is preferably 41%. When the concentration of the tertiary alkali metal hydroxide is within a range of 40% or more and 50% or less, chromium oxide (Cr₂O₃) remaining in the discharge surface treatment coating 14 can be sufficiently dissolved.

The post-washing liquid has a strong alkaline than the main washing liquid. This improves the solubility of chromium oxide (Cr₂O₃) remaining in the discharge surface treatment coating 14. For example, as the tertiary alkali metal hydroxide of the post-washing liquid, an alkali metal hydroxide which is more alkaline than the primary alkali metal hydroxide of the main washing liquid can be used. When the tertiary alkali metal hydroxide of the post-washing liquid and the primary alkali metal hydroxide of the main washing liquid are the same alkali metal hydroxide, the concentration of the tertiary alkali metal hydroxide in the post-washing liquid may be made higher than the concentration of the primary alkali metal hydroxide in the main washing liquid.

As the surfactant, for example, an anionic surfactant, a non-ionic surfactant, or the like can be used. Examples of the surfactant used include a linear alkylbenzene sulfonate, a polyoxyethylene alkyl ether sulfate, and a poly (oxyethylene) nonylphenyl ether. The surfactant of the post-washing liquid may be the same as or different from that of the main washing liquid or that of the pre-washing liquid. When a surfactant is added to the post-washing liquid, the concentration of the surfactant in the post-washing liquid can be within a range of more than 0% and 0.5% or less and is preferably 0.1% or less.

In the post-washing, for example, the discharge surface treatment coating 14 can be immersed in the post-washing liquid and washed. The temperature of the post-washing liquid can be, for example, room temperature. The post-washing liquid may be warmed and used. The immersion time in the post-washing liquid can be 60 to 120 minutes, for example. After the discharge surface treatment coating 14 is post-washed, it is preferably washed with water to remove the post-washing liquid. The post-washing is not limited to immersion, and other washing methods such as spray, shower, and jet may be used.

By post-washing the discharge surface treatment coating 14, the post-washing liquid penetrates into the discharge surface treatment coating 14, and the tertiary alkali metal hydroxide included in the post-washing liquid dissolves chromium oxide (Cr₂O₃) remaining in the discharge surface treatment coating 14. This promotes porousness of the metallic structure of the discharge surface treatment coating 14.

The method for removing the discharge surface treatment coating 14 may include a preliminary washing step for preliminarily washing the discharge surface treatment coating 14. The preliminary washing step is a step of preliminarily washing the discharge surface treatment coating 14 with a preliminary washing liquid including a resolvent. In the preliminary washing step, mainly, oil and the like adhering to the discharge surface treatment coating 14 can be removed. When the pre-washing step (S12) is performed, the preliminary washing step can be performed before the pre-washing step (S12). When the pre-washing step (S12) is not performed, the preliminary washing step can be performed before the main washing step (S10).

The preliminary washing liquid includes a resolvent. The preliminary washing liquid may further contain a surfactant, an alkaline agent, and the like. The preliminary washing liquid includes a resolvent, and the remainder can be made from a solvent. The preliminary washing liquid may contain a resolvent, a surfactant, and an alkaline agent, and the remainder may be made from a solvent. The solvent is preferably water, for example.

The resolvent has a function of removing oil and the like adhering to the discharge surface treatment coating 14. For example, 2-(2-butoxyethoxy) ethanol or the like can be used as the resolvent. The concentration of the resolvent in the preliminary washing liquid can be within a range of 1% or more and 10% or less and is preferably within a range of 3% or more and 8% or less. This is because when the concentration of the resolvent is within a range of 1% or more and 10% or less, the oil and the like adhering to the discharge surface treatment coating 14 can be sufficiently removed.

As the surfactant, for example, an anionic surfactant, a non-ionic surfactant, or the like can be used. Examples of the surfactant used include a linear alkylbenzene sulfonate, a polyoxyethylene alkyl ether sulfate, and a poly (oxyethylene) nonylphenyl ether. The surfactant of the preliminary washing liquid may be the same as or different from that of the main washing liquid, that of the pre-washing liquid, or that of the post-washing liquid. When a surfactant is added to the preliminary washing liquid, the concentration of the surfactant in the preliminary washing liquid can be within a range of 5% or more and 20% or less and is preferably within a range of 10% or more and 15% or less.

As the alkaline agent, ammonia or the like may be used, for example. When an alkaline agent is added to the preliminary washing liquid, the concentration of the alkaline agent in the preliminary washing liquid can be within a range of 0% or more and 0.1% or less and is preferably less than 0.07%.

In the preliminary washing, for example, the discharge surface treatment coating 14 can be immersed in the preliminary washing liquid. The temperature of the preliminary washing liquid can be, for example, room temperature. The preliminary washing liquid may be warmed and used. The immersion time in the preliminary washing liquid can be, for example, 60 to 120 minutes. After the discharge surface treatment coating 14 is preliminarily washed, it is preferably washed with water to remove the preliminary washing liquid. Note that the preliminary washing is not limited to immersion, and other washing methods such as spray, shower, and jet may be used.

In the method for removing the discharge surface treatment coating 14, the main washing step (S10) may be performed once or the main washing step (S10) may be repeated. When the preliminary washing step is performed, it may be performed once before the first main washing step (S10) even when the main washing step (S10) is repeated. After all the steps are completed, drying is preferably performed.

In the method for removing the discharge surface treatment coating 14, the pre-washing step (S12) and the main washing step (S10) may be performed for one cycle, or the pre-washing step (S12) and the main washing step (S10) may be repeated for multiple cycles. When the preliminary washing step is performed, it is sufficient to perform the preliminary washing step once before the first pre-washing step (S12) even when the pre-washing step (S12) and the main washing step (S10) are performed for multiple cycles. After all the steps are completed, drying is preferably performed.

In the method for removing the discharge surface treatment coating 14, the main washing step (S10) and the post-washing step (S14) may be performed for one cycle, or the main washing step (S10) and the post-washing step (S14) may be repeated for multiple cycles. When the preliminary washing step is performed, it is sufficient to perform the preliminary washing step once before the first main washing step (S10) even when the main washing step (S10) and the post-washing step (S14) are performed for multiple cycles. After all the steps are completed, drying is preferably performed.

In the method for removing the discharge surface treatment coating 14, the pre-washing step (S12), the main washing step (S10), and the post-washing step (S14) may be performed for one cycle, or the pre-washing step (S12), the main washing step (S10), and the post-washing step (S14) may be repeated for multiple cycles. When the preliminary washing step is performed, it is sufficient to perform the preliminary washing step once before the first pre-washing step (S12) even when the pre-washing step (S12), the main washing step (S10), and the post-washing step (S14) are performed for multiple cycles. After all the steps are completed, drying is preferably performed.

In the above-described structure, since the main washing step is included, a discharge surface treatment coating can be subjected to main washing using a main washing liquid including sodium permanganate and a primary alkali metal hydroxide. Thus, it becomes possible to oxidize chromium included in the discharge surface treatment coating using sodium permanganate to form chromium oxide (Cr₂O₃), which is an amphoteric oxide, and to dissolve the formed chromium oxide (Cr₂O₃) using the primary alkali metal hydroxide. Consequently, the discharge surface treatment coating becomes more porous, and thus the discharge surface treatment coating can be easily peeled off and removed.

In the above-described structure, since a pre-washing step is included before the main washing step, the discharge surface treatment coating can be pre-washed with a pre-washing liquid including a secondary alkali metal hydroxide. Thus, even when an oxide layer including chromium oxide (Cr₂O₃) is formed on the surface of the discharge surface treatment coating, chromium oxide (Cr₂O₃) can be dissolved by a secondary alkali metal hydroxide to remove the oxide layer.

In the above-described structure, since a post-washing step is included after the main washing step, the discharge surface treatment coating can be post-washed with a post-washing liquid including a tertiary alkali metal hydroxide. Thus, even when chromium oxide (Cr₂O₃) remains in the discharge surface treatment coating, the residual chromium oxide (Cr₂O₃) can be dissolved by a tertiary alkali metal hydroxide and removed.

In the above-described structure, since a preliminary washing step is included, the discharge surface treatment coating can be preliminarily washed in advance with a preliminary washing liquid including a resolvent. Thus, even when oil and the like adheres to the surface of the discharge surface treatment coating, the oil and the like can be removed with a resolvent.

In the above-described structure, since the discharge surface treatment coating coated on the surface of the component is dissolved and removed using a washing liquid, such as the main washing liquid, the discharge surface treatment coating can be removed while suppressing damage to the component compared to when the discharge surface treatment coating is physically removed through mechanical polishing. In the above-described structure, since the component is made from a metallic structure which is denser than the discharge surface treatment coating, the penetration of a washing liquid, such as the main washing liquid, into the component is suppressed. Thus, the discharge surface treatment coating can be removed while the damage of the component, such as corrosion, is suppressed.

### EXAMPLES

Washing treatments were performed on discharge surface treatment coatings coated on the surfaces of substrates to evaluate the peeling property of the discharge surface treatment coatings.

First, test pieces will be described. A test piece was manufactured by coating the surface of a substrate with an discharge surface treatment coating. The substrate was formed with an Ni alloy. The discharge surface treatment coating was formed with a Stellite 31 alloy. The alloy composition of the Stellite 31 alloy contains, by mass ratio, Ni in amount of 9.5% to 11.5%, Fe in an amount of 2.0% or less, C in an amount of 0.45% to 0.55%, Cr in an amount of 24.5% to 26.5%, Mn in an amount of 1.0%, Si in an amount of 1.0%, and W in an amount of 7.5%, and the remainder is made from Co and inevitable impurities.

Next, a method for coating the discharge surface treatment coating will be described. First, an electrode for the discharge surface treatment was manufactured using a Stellite 31 alloy powder. For the Stellite 31 alloy powder, a large particle size powder having an average particle size of 8 μm or less and a small particle size powder having a particle size of 3 μm or less were used. A granulated powder was manufactured by mixing a large particle size powder, a small particle size powder, a binder, and a lubricant. The granulated powder was compressed and molded to form a compact, and then the compact was calcined to form an electrode.

The electrode and the substrate were placed in insulating oil, and a pulsed electric discharge was generated between the electrode and the substrate using a discharge power supply. With this discharge energy, the electrode material is adhered to the surface of the substrate to form a discharge surface treatment coating. The coating thickness of the discharge surface treatment coating is about 500 μm. The test piece was exposed to heat at 750° C. for 100 hours in an atmospheric atmosphere to simulate the operation of the actual machine.

Next, test pieces exposed to heat were subjected to the washing treatment of example 1 and comparative example 1 to evaluate the peeling property of the discharge surface treatment coating. The same test pieces were used in the washing treatments of example 1 and comparative example 1.

First, the washing treatment of example 1 will be described. In the washing treatment of example 1, after the preliminary washing, the pre-washing, the main washing, and the post-washing were performed, the pre-washing, the main washing, and the post-washing were further performed, and ultimately the test piece was dried.

In the preliminary washing, a preliminary washing liquid was used. The preliminary washing liquid included a resolvent in an amount of 3% to 8%, a surfactant in an amount of 10% to 15%, and an alkaline agent in an amount of less than 0.07%, and the remainder was made from water. As the resolvent, 2-(2-butoxyethoxy) ethanol was used. As the surfactant, poly (oxyethylene) nonylphenyl ether was used. As the alkaline agent, ammonia was used. In the preliminary washing, the test piece was immersed in the preliminary washing liquid for 60 minutes and then washed with water.

In the pre-washing, a pre-washing liquid was used. The pre-washing liquid included an alkali metal hydroxide in an amount of 41% and a surfactant in an amount of 0.1% or less, and the remainder was made from water. As the alkali metal hydroxide, sodium hydroxide was used. In the pre-washing, the test piece was immersed in the pre-washing liquid for 120 minutes and then washed with water.

In the main washing, a main washing liquid was used. The main washing liquid included an alkali metal hydroxide in amount of 14% and sodium permanganate in an amount of 3% to 7%, and the remainder was made from water. As the alkali metal hydroxide, sodium hydroxide was used. In the main washing, the test piece was immersed in the main washing liquid for 60 minutes and then washed with water.

In the post-washing, a post-washing liquid was used. The post-washing liquid included an alkali metal hydroxide in an amount of 41% and a surfactant in an amount of 0.1% or less, and the remainder was made from water. As the alkali metal hydroxide, sodium hydroxide was used. In the post-washing, the test piece was immersed in the post-washing liquid for 60 minutes and then washed with water.

Next, the washing treatment of comparative example 1 will be described. In the washing treatment of comparative example 1, only the preliminary washing and pre-washing in the washing treatment of example 1 were performed, and then the test piece was ultimately dried. In the washing treatment of comparative example 1, the main washing and post-washing in the washing treatment of example 1 were not performed.

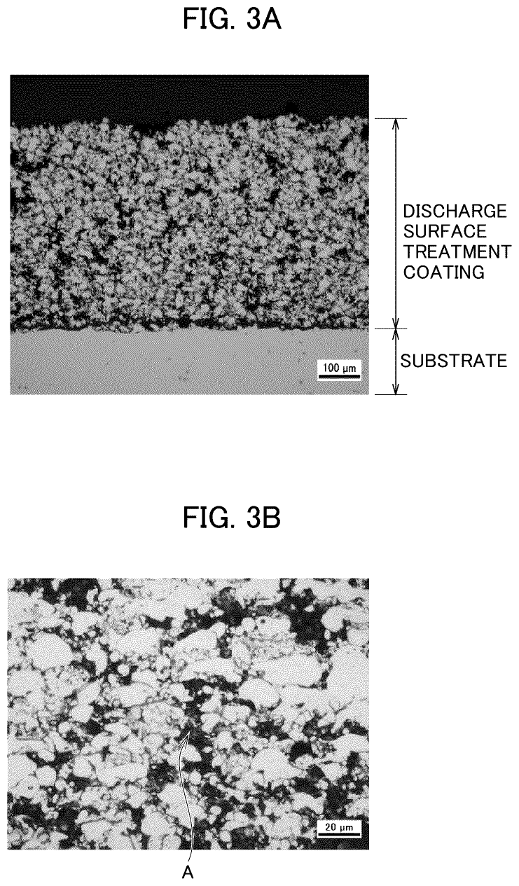

Next, cross-sectional observation of the metallic structure of the test piece was performed. The cross-sectional observation of the metallic structure was performed using an optical microscope. First, the results of the cross-sectional observation of the metallic structure of the test piece before heat exposure will be described. FIG. 3 includes photographs illustrating the cross-sectional observation results of the metallic structure of the test piece before heat exposure, FIG. 3A is a low-magnification overall photograph of the discharge surface treatment coating, and FIG. 3B is a high-magnification enlarged photograph of the discharge surface treatment coating. Note that the arrow A in FIG. 3B indicates a pore part in the discharge surface treatment coating. The discharge surface treatment coating had many pore parts and had a porous metallic structure. In contrast, the substrate had a denser metallic structure than the discharge surface treatment coating.

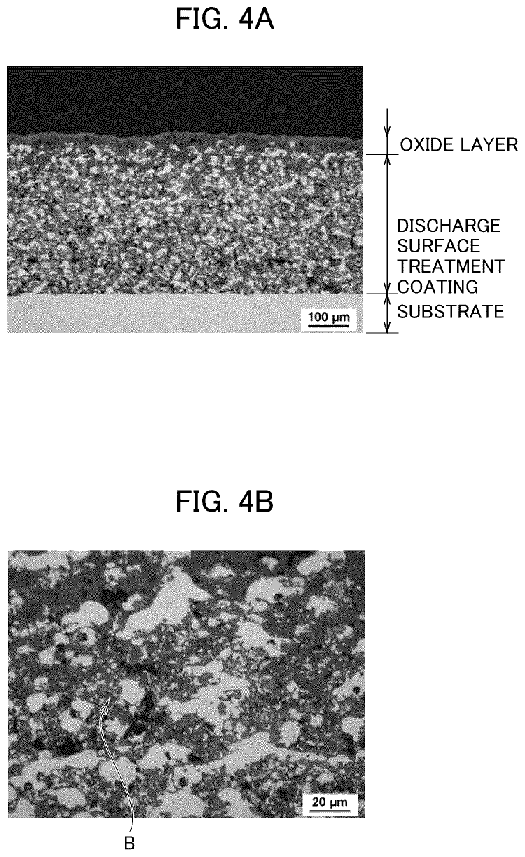

Next, the results of the cross-sectional observation of the metallic structure of the test piece after heat exposure will be described. FIG. 4 includes photographs illustrating the cross-sectional observation results of the metallic structure of the test piece after heat exposure, FIG. 4A is a low-magnification overall photograph of the discharge surface treatment coating, and FIG. 4B is a high-magnification enlarged photograph of the discharge surface treatment coating. In the test piece after heat exposure, an oxide layer including chromium oxide (Cr₂O₃) was formed on the surface of the discharge surface treatment coating. In addition, chromium oxide (Cr₂O₃) was formed on pore parts of the discharge surface treatment coating. It is thought that chromium oxide (Cr₂O₃) was formed due to oxidation of chromium included in the discharge surface treatment coating through heat exposure. Note that the arrow B in FIG. 4B indicates chromium oxide (Cr₂O₃) formed in a pore part of the discharge surface treatment coating.

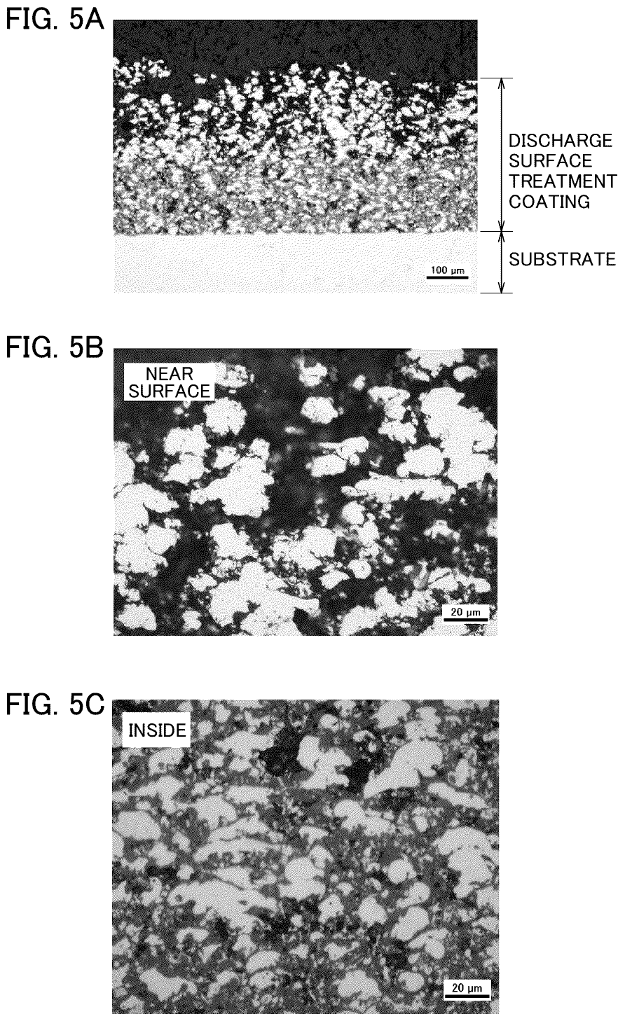

Next, the results of the cross-sectional observation of the metallic structure of the test piece subjected to the washing treatment of example 1 will be described. FIG. 5 includes photographs illustrating the cross-sectional observation results of the metallic structure of the test piece subjected to the washing treatment of example 1, FIG. 5A is a low-magnification overall photograph of the discharge surface treatment coating, FIG. 5B is a high-magnification enlarged photograph near the surface of the discharge surface treatment coating, and FIG. 5C is a high-magnification enlarged photograph inside the discharge surface treatment coating.

In the test piece subjected to the washing treatment of example 1, the oxide layer formed on the surface of the discharge treatment coating after heat exposure was removed. The discharge surface treatment coating of the test piece subjected to the washing treatment of example I had a more porous metallic structure than the discharge surface treatment coating before and after the heat exposure. The surface vicinity of the discharge surface treatment coating had a more porous metallic structure than the inside of the discharge surface treatment coating. Accordingly, the discharge surface treatment coating easily peels off, and thus it was found that the discharge surface treatment coating could be removed.

In addition, damage such as corrosion caused to the substrate by each of the pre-washing liquid, the main washing liquid, the post-washing liquid, and the preliminary washing liquid was suppressed. The reason for this is thought to be mainly that the substrate had a denser metallic structure than the discharge surface treatment coating.

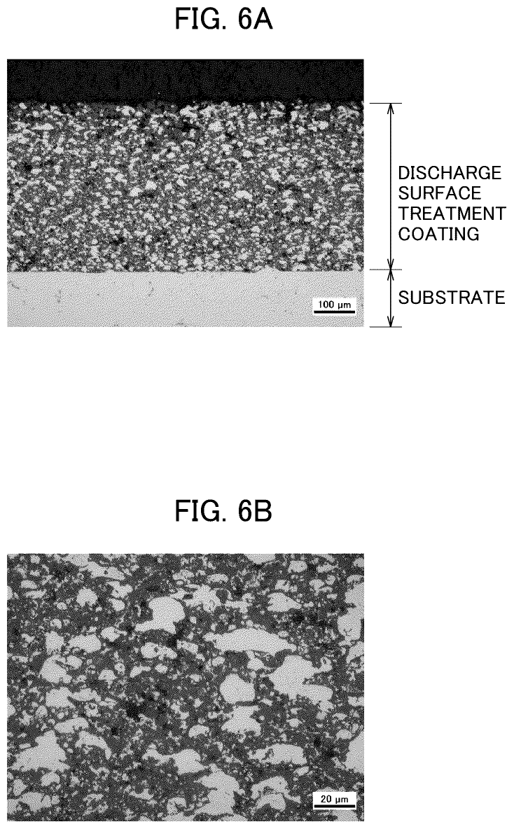

Next, the results of the cross-sectional observation of the metallic structure of the test piece subjected to the washing treatment of comparative example 1 will be described. FIG. 6 includes photographs illustrating the cross-sectional observation results of the metallic structure of the test piece subjected to the washing treatment of comparative example 1, FIG. 6A is a low-magnification overall photograph of the discharge surface treatment coating, and FIG. 6B is a high-magnification enlarged photograph of the discharge surface treatment coating.

In the test piece subjected to the washing treatment of comparative example 1, the oxide layer formed on the surface of the discharge treatment coating after heat exposure was removed. However, the discharge treatment coating of the test piece subjected to the washing treatment of comparative example 1 indicated almost the same metallic structure as the discharge surface treatment coating before and after the heat exposure. That is, the degree of the porosity of the discharge surface treatment coating of the test piece subjected to the washing treatment of comparative example 1 was almost the same as that of the discharge surface treatment coating before and after the heat exposure. From this, it was found difficult to peel off the discharge surface treatment coating and to remove the discharge surface treatment coating in the test piece subjected to the washing treatment of comparative example 1.

The weight change was measured on the test piece subjected to washing treatment of example 1. The weight of the test piece before heat exposure was 22.2920 g. The weight of the test piece after heat exposure was 22.3189 g. The weight of the test piece subjected to the washing treatment of example 1 was 22.2780 g. The weight of the test piece subjected to the washing treatment of example 1 was 0.0409 g less than that of the test piece after heat exposure. Therefore, it was evident that chromium included in the discharge surface treatment coating was dissolved as chromium oxide (Cr₂O₃), which is an amphoteric oxide.

What is claimed is:

1. A method for removing a discharge surface treatment coating coated on a surface of a component,
wherein the discharge surface treatment coating includes chromium, and
the method comprises: a main washing step of performing main washing of the discharge surface treatment coating with a main washing liquid that includes sodium permanganate and a primary alkali metal hydroxide.

2. The method for removing the discharge surface treatment coating according to claim 1, further comprising:
a pre-washing step of pre-washing, before the main washing step, the discharge surface treatment coating with a pre-washing liquid that includes a secondary alkali metal hydroxide, includes no oxidizing agent, and has a strong alkaline than the main washing liquid.

3. The method for removing the discharge surface treatment coating according to claim 2, wherein
the pre-washing liquid includes a surfactant.

4. The method for removing the discharge surface treatment coating according to claim 1, further comprising:
a post-washing step of post-washing the discharge surface treatment coating with a post-washing liquid that includes a tertiary alkali metal hydroxide, incudes no oxidizing agent, and has a strong alkaline than the main washing liquid.

5. The method for removing the discharge surface treatment coating according to claim 4, wherein
the post-washing liquid includes a surfactant.

6. The method for removing the discharge surface treatment coating according to claim 1, further comprising:
a preliminary washing step of preliminarily washing the discharge surface treatment coating with a preliminary washing liquid that includes a resolvent.

7. The method for removing the discharge surface treatment coating according to claim 6, wherein
the preliminary washing liquid includes a surfactant and an alkaline agent.

8. The method for removing the discharge surface treatment coating according to claim 1, wherein
a concentration of the sodium permanganate included in the main washing liquid is within a range of 1% or more and 10% or less.

9. The method for removing the discharge surface treatment coating according to claim 1, wherein
the primary alkali metal hydroxide is sodium hydroxide or potassium hydroxide.

10. The method for removing the discharge surface treatment coating according to claim 2, wherein
the secondary alkali metal hydroxide is sodium hydroxide or potassium hydroxide.

11. The method for removing the discharge surface treatment coating according to claim 4, wherein
the tertiary alkali metal hydroxide is sodium hydroxide or potassium hydroxide.
